(19) United States
(12) Patent Application Publication
(10) Pub. No.: US 2009/0183981 A1
(43) Pub. Date: Jul. 23, 2009

(54) INTEGRATED PYROLYSIS GASOLINE TREATMENT PROCESS

(75) Inventors: Gary G. Podrebarac, Houston, TX (US); Paul B. Himelfarb, Leuna (DE)

Correspondence Address: OSHA LIANG LLP / CDTECH, TWO HOUSTON CENTER, 909 FANNIN STREET, SUITE 3500, HOUSTON, TX, 77010, US

(73) Assignee: CATALYTIC DISTILLATION TECHNOLOGIES, Pasadena, TX (US)

(21) Appl. No.: 12/018,704

(22) Filed: Jan. 23, 2008

(51) Int. Cl. B01D 3/34

(52) U.S. Cl. 203/32

(57) ABSTRACT

An integrated process for treating pyrolysis gasolines, including: feeding the pyrolysis gasoline to a first stage wherein the pyrolysis gasoline is substantially depentanized and acetylene and diolefins are reacted with hydrogen to produce an effluent having a reduced acetylene and diolefin content; and feeding the effluent to a second stage, wherein the second stage comprises a catalytic distillation hydrotreating process. The second stage may include a first catalytic distillation reactor system comprising a first distillation reaction zone containing a first hydrogenation catalyst, and the process may further include treating a C₆-boiling material in the first distillation reaction zone to react sulfur compounds with hydrogen to produce hydrogen sulfide, the treated C₆ material being concurrently separated as a second overheads from C₇ and heavier material by fractional distillation, the C₇ and heavier material being removed from the first distillation reaction zone as a first bottoms.

### BACKGROUND OF INVENTION

1. Field of the Invention

Embodiments disclosed herein relate to a process for the processing of pyrolysis gasoline. More particularly, embodiments disclosed relate to a separation of the pyrolysis gasoline into commercially attractive fractions and treating the fractions to remove or convert unwanted contaminants in an integrated process wherein some separations are carried out concurrently with a specific treatment in distillation column reactors containing the appropriate catalysts.

2. Background Art

Pyrolysis gasoline (also referred to as “pygas”) is a liquid by-product of the steam cracking process to make ethylene and propylene. Pyrolysis gasoline is a highly unsaturated hydrocarbon mixture (carbon range of about C₅-C₁₄) that is rich in dienes, olefin and aromatics, especially benzene. In addition, pyrolysis gasoline includes undesirable heteroatom-containing hydrocarbons, such as sulfur- and nitrogen-containing compounds.

To allow for its use as a gasoline blendstock, pyrolysis gasoline must be at least partially hydrogenated or hydrotreated to reduce the levels of unsaturation and heteroatom-containing hydrocarbons. Left untreated, pyrolysis gasoline typically degrades to form gums and varnishes in fuel systems.

Pygas is not stable, and, in one prior art process, is treated in a two-stage reactor configuration, as illustrated in FIG. 1. The first column DP depentanizes the pygas feed, and the second column HR removes components that boil higher than the desired gasoline end point. The remaining pygas is then treated in a two-stage reactor configuration.

The first stage reactor FSR is commonly loaded with a Pd or Ni catalyst and operated at moderate temperatures (150-375° F.) and at pressures of 20-70 bar in order to cyclodienes, styrene and styrenic (alkenyl benzene) compounds. Typically styrene and styrenic levels in the gasoline to the first stage reactor FSR are in the 2 to 8 wt. % range, more typically 2 to 4 wt. %. Sulfur levels are typically in the 50 to 1000 wt. ppm, more typically 100 to 400 ppm.

Although the pyrolysis gasoline produced from a first stage reactor FSR is sufficiently stable for gasoline blending, the material often cannot be used because of the low sulfur concentration now required in the gasoline pool. This has increased the importance of having a good second-stage reactor SSR. To meet sulfur regulations, the product from the first stage reactor FSR is sent to a second stage reactor SSR having CoMo and/or NiMo catalysts to remove sulfur, where the second stage reactor SSR is typically operated at pressures of 20-70 bar and temperatures of 450-700° F.

Following the second stage, it is fairly common that there is further distillation (C6D, C7D) of the pygas to isolate a C₆ fraction for benzene extraction, or perhaps even a C₇-C₉ faction for toluene/xylenes extraction. For downstream extraction, olefins and sulfur are typically removed to very low levels while aromatics saturation is minimized.

The C₅s are recovered and may be used in gasoline, or in isomerization, etherification and alkylation processes, among others. As noted above, isoprene may be recovered as a useful product. Normally, however, the diolefins are removed along with acetylenes by selective hydrogenation. If desired, the C₅s may be completely hydrogenated and returned to the naphtha cracker ethylene plant as recycle.

The C₆ and heavier fractions contain sulfur compounds which are usually removed by hydrodesulfurization. The aromatic compounds are often removed and purified by distillation to produce benzene, toluene, and xylenes. The aromatic containing fraction is often treated with clay material to remove trace olefinic and diolefinic material.

A common problem with prior second-stage pygas reactors is short run life due to the highly reactive nature of the species in the pygas (even after first stage treatment). Unconverted styrenic compounds and dienes tend to lead to polymer formation and fouling when exposed to the higher temperatures of the second stage. This causes fouling in heaters and high pressure drop across the catalyst bed.

What is still needed therefore is improved catalyst stability and reduced fouling and plugging problems and improved run length in pygas units without a major revamp of the first-stage reactor to increase conversion of styrenics and dienes. It is also desired that such improved processes result in reduced capital or operating costs.

### SUMMARY OF INVENTION

In one aspect, embodiments disclosed herein relate to an integrated process for treating pyrolysis gasolines. The process may include: feeding the pyrolysis gasoline to a first stage wherein the pyrolysis gasoline is substantially depentanized and acetylene and diolefins are reacted with hydrogen to produce an effluent having a reduced acetylene and diolefin content; and feeding the effluent to a second stage, wherein the second stage comprises a catalytic distillation hydrotreating process.

In some embodiments, the second stage may include a first catalytic distillation reactor system comprising a first distillation reaction zone containing a first hydrogenation catalyst, and the process may further include treating a C₆-boiling material in the first distillation reaction zone to react sulfur compounds with hydrogen to produce hydrogen sulfide, the treated C₆ material being concurrently separated as a second overheads from C₇ and heavier material by fractional distillation, the C₇ and heavier material being removed from the first distillation reaction zone as a first bottoms.

Other aspects and advantages of the invention will be apparent from the following description and the appended claims.

### BRIEF DESCRIPTION OF DRAWINGS

FIG. 1 is a simplified flow diagram of a prior art two-stage reactor pygas treating system.

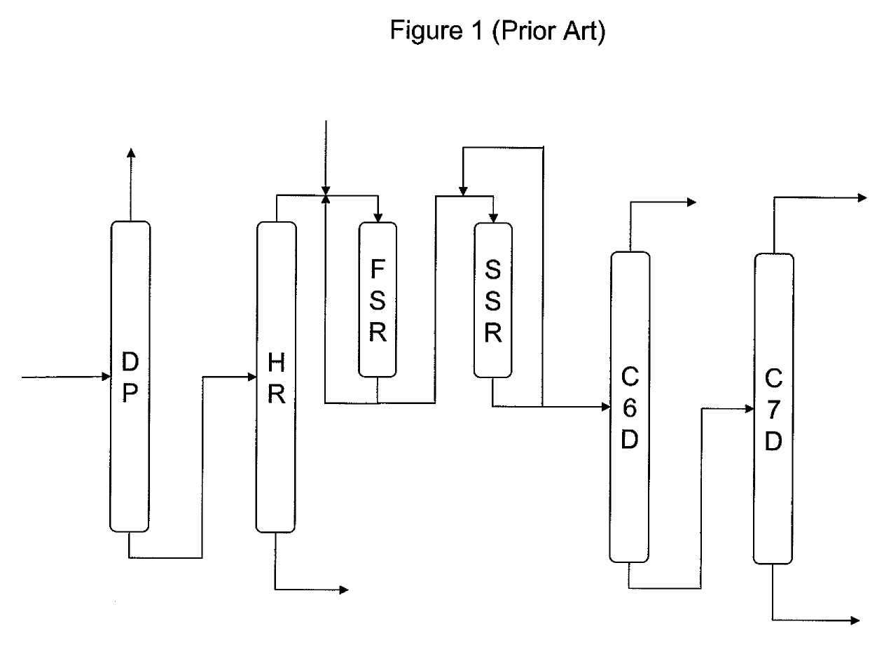

FIG. 2 is a flow diagram in schematic form of a first embodiment of the process for treating pygas according to the present disclosure.

FIG. 3 is a flow diagram in schematic form of a second embodiment of the process for treating pygas according to the present disclosure.

FIG. 4 is a flow diagram in schematic form of a third embodiment of the process for treating pygas according to the present disclosure.

### DETAILED DESCRIPTION

The concurrent reaction and separation of products has been referred to as catalytic distillation or reactive distillation. Within the scope of this application, the expression “catalytic distillation reactor system” denotes an apparatus in which the reaction and the separation of the products take place at least partially simultaneously. The apparatus may comprise a conventional catalytic distillation column reactor, where the reaction and distillation are concurrently taking place at boiling point conditions, or a distillation column combined with at least one side reactor, where the side reactor may be operated as a liquid phase reactor or a boiling point reactor. While both catalytic distillation processes may be preferred over conventional liquid phase reaction followed by separations, a catalytic distillation column reactor may have the advantages of decreased piece count, efficient heat removal (heat of reaction may be absorbed into the heat of vaporization of the mixture), and a potential for shifting equilibrium.

Embodiments disclosed herein use catalytic distillation hydrotreating processes (carried out in a distillation column reactor system) to achieve a number of improvements in pygas treating. Specifically, the present inventors have discovered that catalytic distillation may offer superior catalyst stability and may avoid fouling and plugging problems due to the washing action of the reflux in the column, especially for embodiments in which the second stage hydrotreating is performed in catalytic distillation reactor systems.

As defined herein, hydrotreating is considered to be a process wherein hydrogen is utilized to remove unwanted contaminants by 1) selective hydrogenation, or 2) destructive hydrodesulfarization.

The operation of the distillation column reactor results in both a liquid and vapor phase within the distillation reaction zone. A considerable portion of the vapor is hydrogen while a portion is vaporous hydrocarbon from the petroleum fraction. Within the distillation reaction zone (the zone where a bed of catalyst, usually associated with or prepared as distillation structures, is positioned) there is an internal reflux and liquid from an external reflux which cools the rising vaporous hydrocarbon condensing a portion within the bed.

Without limiting the scope of the invention it is proposed that the mechanism that produces the effectiveness of the present hydrotreating is the condensation of a portion of the vapors in the reaction system which occludes sufficient hydrogen in the condensed liquid to obtain the requisite intimate contact between the hydrogen and the sulfur compounds, olefins, diolefins and the like, in the presence of the catalyst to result in their hydrogenation. In addition, the downward flow of the internal reflux continuously washes the catalyst, which may reduce the build up of coke, coke precursors, and reaction by products, thus increasing catalyst life between regenerations.

The result of the operation of the process in the catalytic distillation mode is that lower hydrogen partial pressures (and thus lower total pressures) may be used to achieve results comparable to the prior art high hydrogen pressure operations. As in any distillation there is a temperature gradient within the distillation column reactor. The temperature at the lower end of the column contains higher boiling material and thus is at a higher temperature than the upper end of the column.

The catalytic material is preferably a component of a distillation system functioning as both a catalyst and distillation packing, i.e., a packing for a distillation column having both a distillation function and a catalytic function, however, the present integrated refinery may also use such systems as described in U.S. Pat. Nos. 5,133,942; 5,368,691; 5,308,592; 5,523,061; and European Patent Application No. EP 0 755 706 A1.

The reaction system can be described as heterogeneous, since the catalyst remains a distinct entity. A preferred catalyst structure for the present hydrogenation reaction comprises flexible, semi-rigid open mesh tubular material, such as stainless steel wire mesh, filled with a particulate catalytic material in one of several embodiments recently developed in conjunction with the present process.

Of particular interest is the structured packing disclosed and claimed in U.S. Pat. No. 5,730,843 which is incorporated. Other catalyst structures useful in the present refinery scheme are described in U.S. Pat. Nos. 5,266,546; 4,242,530; 4,443,559; 5,348,710; 4,731,229 and 5,073,236 which are also incorporated by reference.

The particulate catalyst material may be a powder, small irregular chunks or fragments, small beads and the like. The particular form of the catalytic material in the structure is not critical so long as sufficient surface area is provided to allow a reasonable reaction rate. The sizing of catalyst particles can be best determined for each catalytic material (since the porosity or available internal surface area will vary for different material and, of course, affect the activity of the catalytic material).

Catalysts which are useful in all the reactions described herein include metals of Group VII of the Periodic Table of Elements. Catalysts preferred for the selective hydrogenation of acetylenes and diolefins are alumina supported palladium and nickel catalysts. Catalysts preferred for the hydrodesulfurization reactions include Group VIII metals such as cobalt, nickel, palladium, alone or in combination with other metals such as molybdenum or tungsten on a suitable support which may be alumina, silica-alumina, titania-zirconia or the like.

Generally, the metals are deposited as the oxides on extrudates or spheres, typically alumina. The catalyst may then be prepared as the structures described above, and may be fully or partially sulfided prior to use.

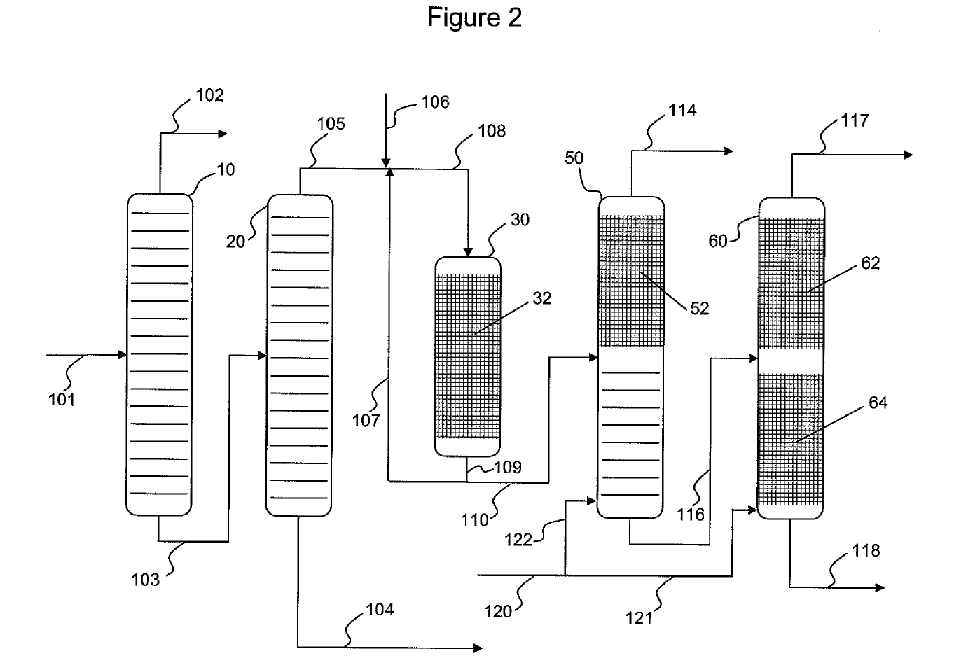

Referring now to FIG. 2, a simplified flow diagram of a pygas treating process according to an embodiment of the present disclosure is illustrated. The feed comprises pyrolysis gasoline which is a complex mixture of predominately hydrocarbon paraffins, naphthenics, acetylenes, dienes, cyclodienes and styrenic compounds (alkynyl benzenes) and other aromatics boiling in the range of 10 to 450° F. Typical pyrolysis gasolines may contain: 4-30% aromatics (2-8% styrene and styrenics), 10-30% olefins, 35-72% paraffins and 1-20% unsaturated containing trace amounts of sulfur (from 100 to 100 wppm), oxygen and/or nitrogen organic compounds. The hydrocarbons are principally C₄-C₈ alkanes, olefins, diolefins, acetylenes, benzene, toluene and xylenes and some heavier residuum.

The pyrolysis gasoline is fed to the depentanizer 10 via flow line 101. In the depentanizer, the C₅s and lighter material are taken as overheads via flow line 102 and sent for further treatment. The C₆ and heavier material is taken as bottoms via flow line 103 and fed to a second distillation column 20, where the end point of gasoline is adjusted by removing unwanted heavy material as bottoms via flow line 104. The pyrolysis gasoline now containing the C₆ to 450° F. boiling material is taken as overheads via flow line 105 and combined with make up hydrogen from flow line 106 and fed via flow line 108 to the first stage hydrogenation reactor 30 containing a bed 32 of hydrogenation catalyst, which is typically nickel or palladium.

The reactor, as shown, is a standard fixed bed trickle flow reactor. The effluent from the reactor 30, including unreacted hydrogen, is taken via flow line 109 and split into two streams. The first, the recycle stream, is recycled to the top of the reactor via flow line 107. The second stream, in flow line 110, is fed to the second stage hydrogenation reactor in the dehexanizer 50 and final splitter column 60. A bed 52 of NiMo or CoMo is placed in the upper end or rectification section of the dehexanizer to treat the C₆ material to prepare it for benzene extraction. C₆s are recovered as an overheads fraction from dehexanizer 50 via flow line 114.

In particular, the sulfur may be removed down to about 50 ppm by weight levels and olefins are reduced. Two beds 62 and 64 of catalyst are placed in the rectification and stripping sections of the final splitter 60 to treat material going to both overhead and bottoms streams, 117 and 118, respectively.

Hydrogen may be supplied via flow lines 120, 122 to column 50 and flow line 121 to column 60. Preferably, the hydrogen is fed below beds 52 and 64. Because the streams are useful for aromatics extraction it is not important to preserve olefins in the second stage hydrogenation, but rather to minimize aromatic saturation.

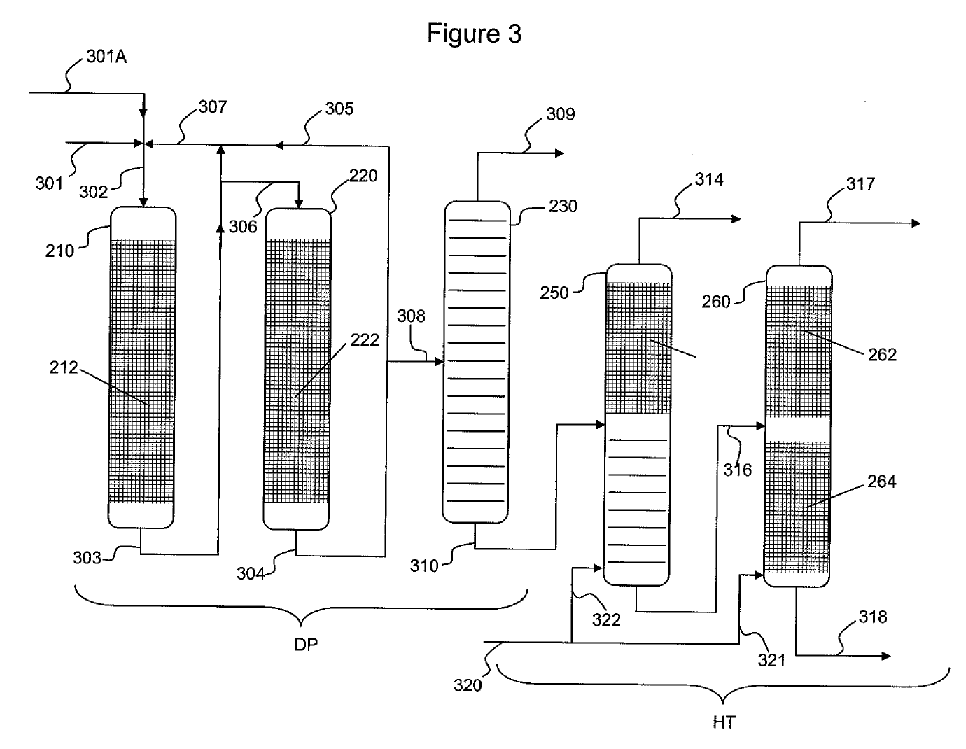

In FIG. 3 there is shown another embodiment in accordance with the present disclosure. Specifically, the embodiments may include a first stage depentanizing step DP coupled with a catalytic distillation hydrotreating step HT.

In the embodiment illustrated in FIG. 3, the pyrolysis gasoline, along with hydrogen, is fed to the first stage reactors via flow lines 301, 301A and 302. The first stage reactor may include one or two downflow trickle bed reactor vessels 210 and 220 containing beds 212 and 222 of nickel or palladium catalyst, respectively. Effluent from the first vessel 210 is taken via flow line 303 and a portion may be recycled back to vessel 210 via flow lines 307 and 302 with the remainder being fed to the second vessel 220 via flow line 306.

The effluent from the second vessel 220 is taken via flow line 304 with a portion being recycled to the top of the first vessel 210 via flow line 305, 307 and 302. The highly reactive materials, such as acetylenes and dienes are saturated in the first stage. Although described above with respect to two down flow reactors 210, 220, processes described herein may include one or more down flow reactors, where, in general, at least a portion of the effluent from the last first-stage reactor may be recycled. The remainder of the effluent is fed via flow line 308 to a first distillation column 230, which acts as a depentanizer to remove the C₅ and lighter material as overheads via flow line 309. Because the highly reactive materials have been removed or converted, fouling in the depentanizer may be reduced or eliminated.

The bottoms from the depentanizer 230 are fed via flow line 310 to a second distillation column 250 which contains a bed 252 of hydrogenation catalyst, particularly Ni—Mo or Co—Mo as oxides supported on an alumina base, in the rectification section to remove sulfur compounds and saturate olefins and any diolefins from the C₆ fraction which is considered benzene concentrate. Hydrogen is fed to the column 250 via flow lines 320 and 322. C₆s are recovered as an overheads fraction from column 250 via flow line 314. The bottoms from the second distillation column are fed via flow line 316 to a third distillation column 260 which contains two beds 262 and 264 in the rectification and stripping sections respectively, treating material going to both overhead and bottoms streams, 317 and 318, respectively. Hydrogen is fed to column 260 via flow lines 320 and 321. The distillation column 250, which treats the C₆ material, is operated as milder conditions than the column 260 which treats the heavier material.

### EXAMPLE

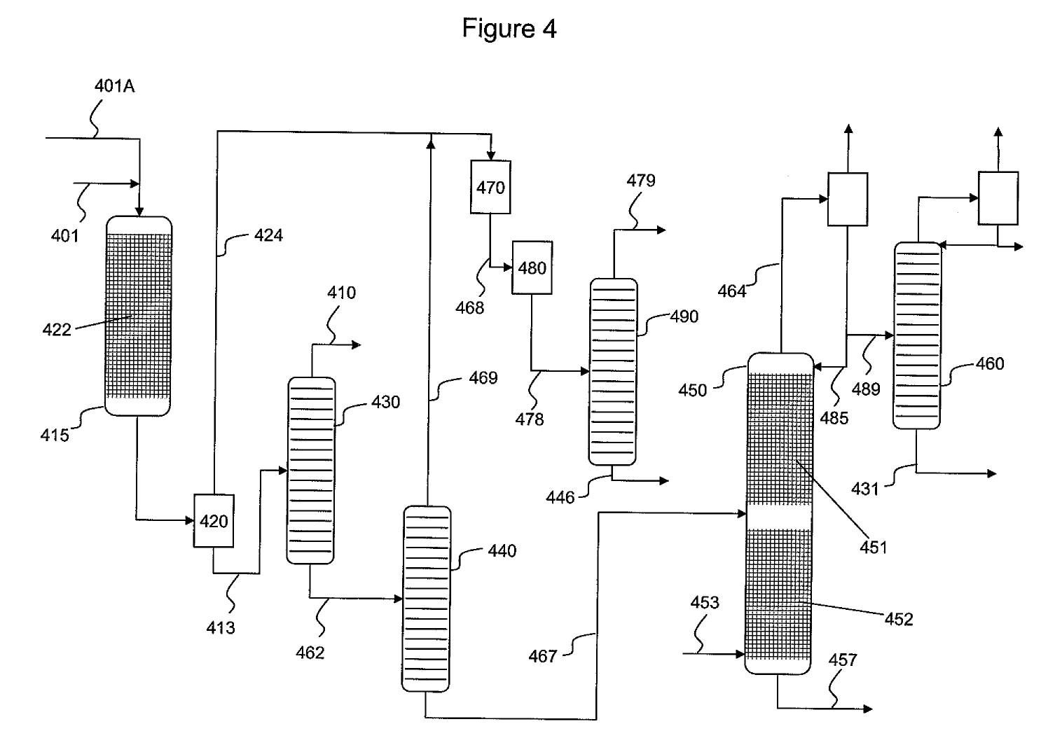

An embodiment of the invention is described in the following example. Feed to the process is 20,000 bbl/day of a typical pygas feed. The stream numbers refer to those in TABLE 1, below, and FIG. 4.

The first step in the process removes most of the styrenic components in the feed stream 401 by reaction with excess H₂ fed via flow line 401A in selective hydrogenation unit (SHU) reactor 415. The SHU reactor is a conventional fixed bed reactor that contains a bed 422 of palladium or nickel catalyst. The vapor stream 424 withdrawn from the cold drum 420, consisting mostly of the excess H₂, may be cascaded downstream to a hydrogenation system which treats the benzene concentrate (described below). The liquid stream 413 withdrawn from the cold drum 420 goes to the depentanizer column 430.

Distillate product from the depentanizer column 430 is a vapor stream 410 comprising C₅ and lighter components. Bottoms product 462 comprising the C₆/C₇₊ components is sent to a benzene concentrate/C₇₊ splitter column 440. The column 440 recovers 99% of the benzene in the feed in the overhead product stream 469.

Bottoms product from the benzene concentrate/C₇₊ splitter column 440 is fed via flow line 467 to a C₇₊ catalytic distillation (CD) hydrotreating system comprising a distillation column reactor 450 (reboiler, heat exchangers, drums, H₂ recycle compressor, and reflux pump are conventional components and not shown).

The distillation column reactor 450 is configured with reaction zones comprised of structured packing containing a Co—Mo catalyst and with trays above and below the reaction zones 451 and 452. The reaction zones are configured above and below the liquid feed point while hydrogen is fed directly into the column below the reaction zones via flow line 453.

Reaction conditions with respect to the temperature and hydrogen partial pressure profiles across the reaction zone needed to achieve desired desulfurization performance with minimal aromatics and olefin loss are feedstock and catalyst dependent. These profiles are in turn dependent on the system pressure and reflux ratio. For this example, the pressure is 250 psig and the reflux ratio is 1.7. Under these conditions, the temperature profile across the reaction zone is essentially flat at 560° F. and the hydrogen partial pressure is 93.7 psi at the bottom of the reaction zone and 84.5 psi at the top of the reaction zone.

The hot vapor distillate stream 464 from the distillation column reactor 450 may provide the heat duty for the depentanizer column 430 and the benzene concentrate/C₇₊ splitter column 440 while being partially condensed and the resulting vapor/liquid mixtures are combined and separated. The liquid fraction may be split to reflux to the distillation column reactor 450, fed via flow line 485, while the remainder is withdrawn via flow line 489 as a hot feed to a C₇₊ stripper-stabilizer column 460. Additional heat may be recovered from the vapor fraction by using it to supply the heat duty for the benzene stripper column 490. The final C₇₊ product stream 431 is obtained after cooling in heat exchangers, for example, heat may be recovered from the hot C₇₊ product 431 by heat exchange with the feed 462 to the benzene concentrate/C₇₊ splitter column 440.

The benzene hydrotreat reactor 470 is a fixed bed-vapor phase-adiabatic reactor. Distillate product stream 469 from the benzene concentrate/C₇₊ splitter 440 is vaporized and combined with H₂ (e.g., recycle and cascaded vapor stream 424) and heated to reaction temperature. Effluent product stream 468 from reactor 470 is partially condensed and vapor/liquid separated via condensers and drums 480. The resulting condensates are fed via flow line 478 to the benzene concentrate/C₇₊ stripper column 490. The H₂ rich vapor fraction 479 may be recycled within the system after removal of a purge.

Benzene concentrate product stream 446 is recovered from the bottom of the stripper column 490 after cooling.

TABLE I

| | | | | | | | |
|---|---|---|---|---|---|---|---|
| Stream No. | 401 | 413 | 469 | 464 | 431 | 468 | 446 |
| Temp. ° F. | 122 | 221 | 232 | 485 | 105 | 298 | 105 |
| Press. PSI | 384 | 368 | 40 | 250 | 97 | 351 | 102 |
| Tot. Mass Flow lb/hr | 260000 | 259766 | 86500 | 467676 | 168192 | 99716 | 86725 |
| Component, | | | | | | | |
| Mass Flow lb/hr | | | | | | | |
| H2 | 0 | 65 | 0 | 4858 | 0 | 5982 | 0 |
| CH4 | 0 | 166 | 0 | 3857 | 0 | 3360 | 0 |
| H2S | 0 | 0 | 0 | 101 | 0 | 52 | 0 |
| N-BUTANE | 0 | 0 | 0 | 2 | 0 | 63 | 32 |
| ISOPRENE | 104 | 8 | 0 | 0 | 0 | 0 | 0 |
| 2M2B | 26 | 111 | 0 | 0 | 0 | 0 | 0 |
| I-PENTANE | 104 | 97 | 0 | 0 | 0 | 87 | 64 |
| CPD | 338 | 24 | 1 | 0 | 0 | 0 | 0 |
| CPENTENE | 260 | 239 | 22 | 0 | 0 | 37 | 32 |
| CPENTANE | 234 | 552 | 138 | 0 | 0 | 174 | 155 |
| 1,4PD | 598 | 48 | 0 | 0 | 0 | 0 | 0 |
| PENTENE | 338 | 481 | 0 | 0 | 0 | 0 | 0 |
| N-PENTENE | 130 | 463 | 678 | 0 | 0 | 59 | 45 |
| 2,3DMBD | 7847 | 682 | 10891 | 0 | 0 | 713 | 675 |
| 2MPENTENE | 7795 | 11040 | 8748 | 0 | 0 | 107 | 100 |
| N-HEXANE | 5196 | 8920 | 61413 | 0 | 0 | 21157 | 19631 |
| BENZENE | 68277 | 62068 | 1364 | 1121 | 616 | 62530 | 60691 |
| CHEXANE | 1299 | 1513 | 787 | 278 | 149 | 2023 | 1974 |
| HEPTENE | 7795 | 6023 | 2389 | 1981 | 988 | 0 | 0 |
| N-HEPTANE | 5196 | 6947 | 0 | 17308 | 8870 | 3277 | 3233 |
| TOLUENE | 48847 | 48615 | 0 | 108207 | 48391 | 66 | 66 |
| MCHEXANE | 2650 | 2821 | 0 | 6410 | 3014 | 7 | 7 |
| STYRENE | 11692 | 2104 | 0 | 7 | 2 | 0 | 0 |
| EBENZENE | 5093 | 14861 | 0 | 46237 | 17082 | 4 | 4 |
| ′XYLENE | 22709 | 22704 | 0 | 62265 | 22574 | 5 | 5 |
| 2,5DMHEXD | 156 | 13 | 0 | 0 | 0 | 0 | 0 |
| OCTENE | 4489 | 3974 | 0 | 1882 | 818 | 4 | 3 |
| OCTANE | 5794 | 6965 | 0 | 24071 | 10187 | 6 | 6 |
| INDENE | 4807 | 1485 | 0 | 247 | 63 | 0 | 0 |
| INDANE | 364 | 3743 | 0 | 19342 | 5178 | 0 | 0 |
| MSTYRENE | 9717 | 4133 | 0 | 2007 | 554 | 0 | 0 |
| IPBENZENE | 19123 | 24800 | 0 | 88056 | 28255 | 2 | 2 |
| DCPD | 11666 | 1644 | 0 | 0 | 0 | 0 | 0 |
| UNDECANE | 1039 | 1039 | 0 | 4278 | 1034 | 0 | 0 |
| C10NAPH | 4105 | 5726 | 0 | 51005 | 15239 | 0 | 0 |
| DHDCPD | 3040 | 11618 | 0 | 8900 | 1822 | 0 | 0 |
| DMCHEXANE | 0 | 0 | 0 | 320 | 132 | 0 | 0 |
| IPCHEXANE | 0 | 0 | 0 | 578 | 132 | 0 | 0 |
| DODECANE | 2598 | 2598 | 0 | 9631 | 2016 | 0 | 0 |
| BENZOTHIO | 109 | 109 | 0 | 0 | 0 | 0 | 0 |
| THIOPHENE | 68 | 68 | 66 | 0 | 0 | 0 | 0 |
| MEINDENE | 1299 | 1299 | 0 | 769 | 175 | 0 | 0 |
| MEINDANE | 0 | 0 | 0 | 3959 | 852 | 0 | 0 |

In addition to the above described embodiments, other flow and reaction configurations may be possible. Flow configurations in some embodiments may result in the first stage reactor treating all or a portion of the pygas feed (e.g., the depentanizer location may be varied). In other embodiments, the second stage catalytic distillation reactors may include additional reaction zones, such as catalyst in the lower portion of the de-C₆ column to treat the heavier gasoline. Other embodiments may also be envisaged where the second stage treatment is conducted in catalytic distillation reactor systems, depending on various heat integration issues and other site-specific factors.

Thus, by employing catalytic distillation hydrotreating techniques and apparatuses, the present inventors advantageously may improve run length in pygas units without a major revamp of the first-stage reactor to increase conversion of styrenics and dienes. This represents a significant benefit. A further capital cost advantage can be gained through the combination of two unit operations. Namely, the second stage hydrotreating step can be conducted in the same column(s) that isolate the C₆ fraction for benzene extraction, or any other suitable downstream column.

Improved stability of the catalyst through use of catalytic distillation may also allow for reduced temperatures and pressures (reduced severity) in the first stage reactor, thus improving cycle length in the first stage reactor. Further, embodiments disclosed herein may advantageously allow the distillation columns fractionating untreated pyrolysis gasoline to be operated at much lower pressure as compared to typical operating conditions, which reduces the likelihood of fouling of the reboilers.

Additionally, embodiments disclosed herein may perform, in a single multifunctional distillation column, many of the separate steps and processes as described above with respect to the prior art. Processes disclosed herein may also allow for energy savings as compared to prior art processes.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. An integrated process for treating pyrolysis gasolines comprising:
feeding the pyrolysis gasoline to a first stage wherein the pyrolysis gasoline is substantially depentanized and acetylene and diolefins are reacted with hydrogen to produce an effluent having a reduced acetylenes and diolefins content; and
feeding the effluent to a second stage, wherein the second stage comprises a catalytic distillation hydrotreating process.

2. The integrated process of claim 1, wherein the second stage comprises a first catalytic distillation reactor system comprising a first distillation reaction zone containing a first hydrogenation catalyst, and further comprising
treating a C₆-boiling material in said first distillation reaction zone to react sulfur compounds with hydrogen to produce hydrogen sulfide, the treated C₆ material being concurrently separated as a second overheads from C₇ and heavier material by fractional distillation, the C₇ and heavier material being removed from the first distillation reaction zone as a first bottoms.

3. The integrated process according to claim 2, further comprising:
feeding hydrogen and the first bottoms to a second distillation reaction zone containing a second hydrogenation catalyst in a rectification section and a third hydrogenation catalyst in a stripping section to react sulfur compounds with hydrogen to produce hydrogen sulfide and wherein C₇-C₉ material is concurrently separated as a overheads from C₁₀ and heavier material by fractional distillation, the C₁₀ and heavier material being removed as a second bottoms.

4. The integrated process according to claim 2, wherein the first distillation reactor system comprises a catalytic distillation zone for hydrotreating a C₇₊-boiling hydrocarbon fraction.

5. The integrated process according to claim 4, wherein the treated C₇₊ fraction is separated into two or more hydrocarbon fractions in a distillation column.

6. The integrated process according to claim 5, wherein the distillation column comprises one or more catalytic distillation zones for hydrotreating at least a portion of the treated C₇₊ fraction.

7. The integrated process according to claim 3, wherein the first, second, and third hydrogenation catalysts comprise the oxides of nickel and molybdenum supported on an alumina base.
